(19) United States
(12) Patent Application Publication
(10) Pub. No.: US 2026/0231944 A1
(43) Pub. Date: Aug. 13, 2026

(54) ANTISEPTIC CONDITIONING FORMULATIONS

(71) Applicant: THOMMES MEDICAL AG, Grenchen (CH)

(72) Inventors: Franziska KOCH, Kandern (DE); Jasmin WASER, Ormalingen (CH)

(73) Assignee: THOMMES MEDICAL AG, Grenchen (CH)

(21) Appl. No.: 19/152,657

(22) PCT Filed: Jan. 30, 2024
(86) PCT No.: PCT/EP2024/052208

§ 371 Date: Jul. 31, 2025

(30) Foreign Application Priority Data
Feb. 1, 2023 (EP) 23154365.3
Jul. 20, 2023 (EP) 23186724.3

(51) Int. Cl. A01N 47/44; A01N 25/02

(52) U.S. Cl. CPC A01N 47/44; A01N 25/02

(57) ABSTRACT

An aqueous antimicrobial composition comprising or consisting of the following components: (a) polyhexanide (PHMB) or a salt thereof in a concentration in the range of 0.001-0.2% w/v; (b) an organic or inorganic buffer different from a) with at least one pKs value in the range of 8.5-11.5 in a concentration in the range of 0.01-1 M; (c) further additives in a concentration in the range of 0-20% w/v; (d) water; wherein the pH value of the composition is in the range of 8-11.5.

### TECHNICAL FIELD

The present invention relates to antiseptic formulations, in particular to antiseptic conditioning formulations as well as to uses thereof and methods of manufacturing corresponding formulations.

### PRIOR ART

There has been an increasing focus on compositions that impart antimicrobial properties to products and surfaces, in particular during the pandemic. Some pathogenic bacteria have evolved to become resistant to most, if not all, of the currently available antibiotics on the market. These drug-resistant bacteria present a challenge to the healthcare industry. Furthermore, in the food industry, bacteria infestation related recalls have become more prevalent due to current cleaning methods being insufficient. Even consumers are seeking solutions to this issue with products that impart antibacterial properties to architectural paints and homecare and laundry products.

Before or after implantation, cleaning of implants and removing biofilms is important to prevent inflammation or reduce inflammation risks, respectively.

Also, antiseptic formulations are used for rinsing body parts, for example for mouth rinsing, wound treatment, skin disinfection and the like.

To this end various different antiseptic formulations are known to the skilled person, typical antiseptic formulations include aqueous or at least partly aqueous formulations of antiseptic agents such as octenidine (1,1′-(decane-1,10-diyl)bis(N-octylpyridin-4(1H)-imine)-hydrogen chloride), chlorhexidine (1,6-bis(4-chloro-phenylbiguanido)hexane) or polyhexanide (polyhexamethylene biguanide), but also strongly basic or acidic solutions or solutions based on inorganic antiseptic systems.

JP-A-2007045732 provides a disinfection solution mild to the skin and having effects for inactivating Norovirus. The antiseptic solution contains 0.05-0.5 wt. % polyhexamethylene biguanide-based compound and has a pH within the range of 9-12.

EP-A-1049763 relates to aqueous biguanide-containing disinfecting solutions containing an improved buffer system comprising both a phosphate and borate buffer. Preferred embodiments include methods and compositions for simultaneously cleaning and disinfecting contact lenses.

### SUMMARY OF THE INVENTION

It is thus an object of the present invention to provide improved antiseptic formulations, in particular for conditioning for example of implants, which make use of in as little as possible concentration of organic antiseptic compounds, which are compatible with the body and/or the surfaces to which the formulations are applied, and which show and as high as possible antiseptic effect while at the same time an as high as possible biocompatibility.

This object is achieved by the subject matter as claimed, more specifically by compositions as claimed, uses of such compositions and methods for making such compositions.

According to a first aspect of the present invention it relates to an aqueous antimicrobial composition comprising or consisting of the following components:
(a) polyhexanide (PHMB) or a salt thereof in a concentration in the range of 0.001-0.2% w/v;
(b) an organic or inorganic buffer different from a) with at least one pKs value in the range of 8.5-11.5 in a concentration in the range of 0.01-1 M;
(c) further additives in a concentration in the range of 0-20% w/v;
(d) water;
wherein the pH value of the composition is in the range of 8-11.5.

Polyhexanide is polyhexamethylene biguanide, which typically has a weight average molecular weight Mw in the range of 1500-4000 g/mol, preferably in the range of 2400-3000 g/mol.

Furthermore, the polyhexanide (PHMB) of component (a) typically has a polydispersity (PDI) in the range of 1.4-2.2, preferably in the range of 1.7-2.8.

Normally, the starting material for the preparation of the corresponding composition is a salt of polyhexanide, in particular polyhexamethylene biguanide hydrochloride, and the weight percent in terms of the total weight of polyhexamethylene biguanide hydrochloride.

Generally speaking, when giving percentages in w/v, this means the measure of weight of the corresponding substance in g per 100 mL, and the unit is g/cm³ which equals 1 kg/dm³ which equals 1000 kg/m³. 1% v/w thus corresponds to 1 g/100 mL which equals 0.01 g/cm³. Furthermore, the pKs values as given are in water under standard laboratory conditions, i.e. 20° C. and 101 325 Pa.

Where pH values are given they are typically measured using calibrated pH/conductometres, after calibration, under standard laboratory conditions for example using a device of the type 914 pH/Conductometer-Metrohm.

The water in the composition is typically nano pure water, i.e. water according to ASTM type I.

In fact, it was unexpectedly found as will be evidenced in the experimental section further below, that the antibacterial efficacy of polyhexanide can be greatly enhanced by adjusting the pH in the range as claimed and by stabilising it in that range by providing a corresponding buffer, preferably in the claimed concentration.

Without being bound to any scientific explanation, it seems based on the experimental evidence that this is not only a combination of the antibacterial effect due to the high pH value and the polyhexanide activity, but the experimental evidence shows that there is a synergistic effect in the claimed concentration window for the polyhexanide, allowing, to achieve the same disinfecting or preventing effect, a reduction of the concentration of the polyhexanide or, using the same concentration, to achieve a more pronounced disinfecting or preventing effect.

Preferably, the aqueous antimicrobial composition is free from ethanol or comprises less than 10% w/v or less than 5% w/v or less than 2% w/v of ethanol.

Alternatively and also preferably, the aqueous antimicrobial composition is free from linear or branched alkyl or arylalkyl monohydric alcohols with 1-9 or 1-6 carbon atoms (in particular free from methanol, ethanol, propanol, 1-phenyl-1-propanol or a combination thereof) or comprises less than 10% w/v or less than 5% w/v or less than 2% w/v or less than 1% w/v of such linear or branched alkyl or arylalkyl monohydric alcohols.

As defined above, the composition may consist of components (a)-(d). It may however also comprise further components, in particular according to a preferred embodiment it further comprises component (e), preferably in this case it then consists of components (a)-(e). So according to a preferred embodiment, next to components (a)-(d) the composition further comprises the following component (preferably this component (e) is the only additional component, so the formulation consists of (a)-(e), further including the means to adapt the pH to the claimed value of in the range of 8-11.5, preferably in the form of NaOH): (e) at least one sugar alcohol having at least three carbon atoms.

Sugar alcohols (also called polyhydric alcohols, polyalcohols, alditols or glycitols) are to be understood as organic compounds, typically derived from sugars, containing one hydroxyl group (—OH) attached to each carbon atom. They are normally white, water-soluble solids that can occur naturally or can be produced industrially by hydrogenating sugars. Since they contain multiple-OH groups, they are classified as polyols. Sugar alcohols according to this disclosure are systems of this type having at least three carbon atoms, preferably 4-12 carbon atoms, particularly preferably 4-6 carbon atoms or exactly 6 carbon atoms. Sugar alcohols can be added to influence the taste and/or the viscosity of the composition and due to this effect may synergistically influence the efficacy of the other components, in particular of component (a) combined with (b).

Preferably the at least one sugar alcohol having at least three carbon atoms is present in the composition in a concentration of up to 75% w/v, preferably in a concentration of up to 70% w/v or in the range of 2-50% or 5-50% w/v or in the range of 3-40% or 10-40% w/v or 4-10% or 20-30%.

Preferably said sugar alcohol of component (e) is selected from the group consisting of glycerol, erythritol, threitol, arabitol, ribitol, mannitol, sorbitol, xylitol, galactitol, fucitol, iditol, inositol, volemitol, isomalt, maltitol, lactitol, maltotriitol, maltotetraitol, or a combination thereof.

Correspondingly, according to a preferred embodiment, the concentration of the polyhexanide (PHMB) of component (a) in the composition is in the range of 0.002-0.15% w/v or 0.002-0.1% w/v, preferably in the range of 0.005-0.07% w/v or 0.005-0.05% w/v, in particular in the range of 0.007-0.03% w/v or 0.007-0.02% w/v or 0.007-0.015% w/v. A particularly high synergistic effect of the high pH value and of the polyhexanide presence can be achieved if the concentration of the pH and B is in the range of 0.01% w/v using polyhexanide hydrochloride as starting material.

Preferably, the organic or inorganic buffer of component (b) is selected from the following systems:
amino acid, in particular selected from the group consisting of alanine, glycine, asparagine, isoleucine, leucine, serine, threonine, valine, or a combination thereof, in particular glycine;
bicarbonate buffer, in particular selected from the group consisting of: carbonate bicarbonate buffer, triethyl ammonium bicarbonate buffer;
borate buffer, in particular sodium borate buffer;
(acetic acid) ethanolamine buffer;
   or a combination or mixture thereof.

With particular preference the organic or inorganic buffer of component (b) is selected from the group consisting of short-chain amino acids having no side-chain leading to a pKs value and having a pKs value in the claimed range, preferably glycine, alanine, valine, leucine, isoleucine, or a combination or mixture thereof.

Particularly preferably the buffer is selected as a glycine buffer, in particular in a concentration in the range of 0.05-0.2 M. It seems that range is just sufficient to stabilise the pH in the desired range and to optimally cooperate with the other components in the composition.

Generally speaking, preferably the organic or inorganic buffer of component (b) has at least one pKs value in the range of 9-10.5, preferably in the range of 9.5-10.

Also generally speaking, the concentration of the organic or inorganic buffer of component (b) in the composition is in the range of 0.05-0.8 M, preferably in the range of 0.08-0.5 M, in particular in the range of 0.1-0.2 M.

The pH value of the buffer of component (b) or rather of the whole composition is, if needed, adapted to the claimed pH value in the range of 8-11.5 preferably by adding a preferably strong, preferably inorganic base, said base preferably being selected from the group consisting of NaOH, KOH, Ca(OH)₂, NaClO, KClO, or a combination thereof. Typically, the concentration of that base in the composition is in the range of 0.001-0.07 M or 0.04-0.06 M or in the range of 0.045 M-0.055 M, so in particular around 0.05 M.

Preferably the buffer (b) is glycine at a concentration in the range of 0.05-0.2 M adjusted in pH with an alkali metal hydroxide, in particular selected as NaOH, KOH or a mixture thereof, at a concentration in the range of 0.04-0.06 M.

It is further preferred that as component (c) the additives are selected from the group: poloxamer, polyethylene glycol, flavouring agents, colouring agents, sugar alcohol, calcium donor or derivatives or combinations thereof, in a concentration in the range of 0-10% w/v. Particularly preferred is a composition, wherein the additives of component (c) are selected as
1-3% w/v poloxamer, preferably poloxamer having the structure EOₙ-POₘ-EOₙ, wherein n is in the range of 80-120 and m is in the range of 50-60,
1-3% w/v polyethylene glycol and/or ethoxylated vegetable oil, in particular both, with ethoxylated castor oil preferably being used,
0.1-0.4% w/v flavouring substances, preferably selected as flavouring oil
2-10% w/v sugar alcohol, preferably xylitol,
0.0-0.05% w/v or 0.01-0.05% w/v calcium donor,
preferably the composition having a pH in the range of 9.5-10.

As pointed out above, the composition may comprise additives/auxiliaries different from the components (a) and (b) or (a)-(e).

These additives of component (c) can be selected from the group consisting of: surfactants, anti-corrosion agents, taste modifiers (different from the above mentioned sugar alcohols), perfumes, dyes, stabilisers, thickeners (different from the above mentioned sugar alcohols), complexing agents, organic solvents, in particular alcohols (different from the above mentioned sugar alcohols), further disinfectants, preservatives, taste modifiers (different from the above mentioned sugar alcohols), thickeners (different from the above mentioned sugar alcohols) or mixtures or combinations thereof.

Examples for taste modifiers (different from the above-mentioned sugar alcohols) are one or a combination of: natural or synthetic fragrances, essential oils, tannic acid, menthol, sodium cyclamate, fructose, galactose, thymol. Taste modifiers (different from the above-mentioned sugar alcohols) are typically in a concentration in the range of 0.01-10% w/v, preferably in the range 0.1-5%, with respect to the aqueous antimicrobial composition. Examples for thickeners (different from the above-mentioned sugar alcohols) are one or a combination of: gelatin, polyethylene glycol, e.g. polyethylene glycol 1000, polyvinyl alcohol, silicon dioxide, starch, poloxamer (e.g. 188, 407), carrageenan. Thickeners (different from the above-mentioned sugar alcohols) are typically in a concentration in the range of 1-20% w/v with respect to the aqueous antimicrobial composition.

The surfactants can be ionic, non-ionic or amphoteric surfactants.

Anionic surfactants of these additives are in particular selected from alkyl sulfates, alkyl ether sulfates, alkyl sulphonates, alkylbenzyl sulfonates, α-olefin-sulphonates, alkylamide sulphonates, alkarylpolyether sulphates, alkylamidoether sulfates, alkyl monoglyceryl ether sulfates, alkyl monoglyceride sulfates, alkyl monoglyceride sulfonates, alkyl succinates, alkyl sulfosuccinates, alkyl ether sulfosuccinates, alkyl sulfosuccinamates, alkyl amidosulfosuccinates; alkyl sulfoacetates, alkyl phosphates, alkyl ether phosphates, alkyl ether carboxylates, alkyl amidoethercarboxylates, acyl lactylates, alkyl isethionates, acyl isethionates, carboxylate salts and amino acid derived surfactants such as N-alkyl amino acids, N-acyl amino acids, alkyl peptides, and mixtures thereof.

Amphoteric surfactants of these additives can in particular be selected from alkyl betaines; alkylamido betaines; alkylamido sultaines; alkyl mono- and di-amphocarboxylates; amine oxides; and mixtures thereof.

Nonionic surfactants of these additives for example can be selected from ethoxylated fatty alcohols, ethoxylated alkylphenols, ethoxylated Guerbet alcohols, ethoxylated vegetal oils (e.g. ethoxylated castor oil, e.g. of the PEG-40 type, such compounds may e.g. help dissolving further components), polypropylene glycol, polyethylene glycol, block copolymers of propylene glycol and/or ethylene glycol, ethoxylated sorbitan esters, sorbitan esters, alkyl polyglucosides, alkyl glucamides, and mixtures thereof.

The concentration of the surfactants of component (c) can be zero or more than zero and in the range of less than 10% w/v or less than 5% w/v with respect to the total composition. The concentration of the additives of component (c) can be in the range of less than 10% w/v or less than 5% w/v.

As for the dyes of component (c) these typically are present in the composition in a concentration of less than 0.2% w/v, preferably in the range of less than 0.1% w/v, particularly preferably in the range of 0.001-0.05% w/v with respect to the total composition. Further preferably, additives other than thickeners (different from the above mentioned sugar alcohols) and taste modifiers (different from the above mentioned sugar alcohols) are in the range of less than 0.2% w/v, preferably in the range of less than 0.1% w/v, particularly preferably in the range of 0.001-0.05% w/v, this for example in combination with a proportion of thickeners (different from the above mentioned sugar alcohols) in the range of 1-19.8% w/v with respect to the total composition.

For some application is preferred if there are no additives, so the additive content is essentially 0.0 w/v with respect to the total composition.

According to another preferred embodiment of the proposed composition, the composition has a calcium content as an additional component or as part of component (c) in the range of 1-5 mmol/L, preferably 2-3 mmol/L, which is the total, and the calcium can be in ionic form or in ionic bound form (in particular bound on albumin).

Typically the Ca²⁺ is introduced into the composition as CaCl₂), Ca citrate, Ca(OH)₂, Ca lactate, calcium carbonate or Ca phosphate or combinations thereof.

As pointed out above, one important characteristic of the composition is the pH value which is adapted to the higher pKs of the polyhexanide system, which is in the range of 12. The pH value of the composition should be below that value.

According to a preferred embodiment, the composition has a pH value in the range of 8-11, preferably in the range of 8.5-10.5, in particular in the range of 9.5-10. an optimum effect is achieved if the pH is somewhere around 9.8.

According to a particularly preferred embodiment the composition consists of (a)-(d) or (a)-(e), the polyhexanide (PHMB) of component (a) has a weight average molecular weight Mw in the range of 2400-3000 g/mol, the polyhexanide (PHMB) of component (a) takes the form of polyhexamethylene biguanide hydrochloride, and the concentration of the polyhexanide (PHMB) of component (a) in the composition is in the range of 0.007-0.015% w/v. Furthermore, the organic or inorganic buffer of component (b) is selected as glycine in a concentration of the organic or inorganic buffer of component (b) in the composition in the range of 0.1-0.2 M, and the concentration of the further additives of component (c) is less than 0.01% w/v, preferably in the range of 0.001-0.01% w/v.

According to a further aspect of the present invention it relates to specific uses of such a composition.

Therapeutic uses of such a composition (also formulated as “Composition for use as . . . ”) include wound care (generic), including for use as purification solution, debridment with solution, wound cleansing solution, wound care solution, wound management, in particular promotion of wound healing in the early healing phase in the oral cavity, priming/conditioning of wound/injured area, support purification phase during primary healing phase, clean & moisten of wounds, or combinations thereof.

Therapeutic uses of such a composition (also formulated as “Composition for use as . . . ”) also include wound irrigation (as wound irrigation solution), uses for antimicrobial decontamination and prevention of infection, infection prophylaxis and for reducing antimicrobial load oral cavity.

Therapeutic uses as described can be for the treatment of humans or animals, and can be preventive uses or curative uses.

According to this aspect of the invention, what is proposed is a composition as defined above for the treatment or prevention of bacterial infection or bacterial colonisation or both, in particular of the skin, wounds, preferably of the mouth.

Or put differently, the invention relates to the use of such a composition for the treatment or prevention of bacterial infection or bacterial colonisation or both, in particular of the skin, wounds, preferably of the mouth.

According to a first preferred embodiment the composition is for the treatment and/or prevention of patients during and/or after implantation, in particular during and/or after dental implantation, preferably in the form of a rinsing or washing composition or drip solution, including after-care treatment over the days or even weeks following implantation. Non-therapeutic uses are intended to be applied to non-living objects, for example hard surfaces or implants, and if applied to humans or animals they are applied to healthy humans or animals without need of therapy or prevention for purely disinfecting reasons.

According to this further aspect of the present invention, it relates to the use of a composition as detailed above for the disinfecting non-therapeutic treatment of surfaces, in particular non-living surfaces, preferably by dip coating, spraying, dripping, or for storage and/or implantation preparation of devices, in particular implants but also biomaterials for soft or hard tissue regeneration.

According to a first preferred embodiment of this aspect, the composition is used for storing an implant or a biomaterial, for example for soft or hard tissue regeneration, in particular a dental implant, in immersion before use, or is packaged together or as kit of part with an implant or a biomaterial, for example for soft or hard tissue regeneration, in particular a dental implant, for the implant or biomaterial to be immersed or wetted by the composition shortly before implantation.

Also the present invention relates to a method for cleaning and sanitizing and/or disinfecting a surface and providing residual inhibition against microbes, the method comprising: a) applying the composition as detailed above to a surface, article and/or substrate.

Furthermore, the present invention relates to a method for making a composition as detailed above, comprising preferably the steps of providing an aqueous sodium hydroxide solution and it with the polyhexanide and the buffer in the required proportions and adding additives if needed before or after, followed by mixing.

The compositions can be stored in containers without the need of cooling, preferably corresponding containers are glass or plastics container, and such containers may be combined with objects to which the corresponding compositions are to be applied before use, for example possible are combination packages including a container for the composition as described above and another separate container for the corresponding object, for example an implant. Also such a package may be structured such that the container with the composition can be opened by manipulation such that the composition flows into the packaging compartment of the object for direct wetting and/or immersion.

Further embodiments of the invention are laid down in the dependent claims.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1 shows results of early in vitro biofilm model set tests of the synergistic antimicrobial effect of testing reagents in alkaline buffers for low PHMB concentrations;

FIG. 2 shows results of early in vitro biofilm model set tests of the synergistic antimicrobial effect of testing reagents in alkaline buffers for medium PHMB concentrations;

FIG. 3 shows results of early in vitro biofilm model set tests of the synergistic antimicrobial effect of testing reagents in alkaline buffers for higher PHMB concentrations;

FIG. 4 in a) shows results of denser and older biofilm model tests of the synergistic antimicrobial effect of testing reagents in alkaline buffers for higher PHMB concentrations, and in b) shows the behaviour of Streptococcus sanguinis cultured in either neutral PBS (pH 7.2) or in alkaline T. buffer (pH 9.7) or in alkaline T. buffer spiked with 0.015% PHMB;

FIG. 5 shows the results of the biocompatibility tests of the different alkaline buffers;

FIG. 6 shows the results of the biocompatibility tests of PHMB and CHX for different concentrations;

FIG. 7 shows the cell viability of human primary cells after the treatment with various antiseptics at concentrations as used in products that are currently on the market;

FIG. 8 shows the effect of the additive ethanol at 10, 20 and 50% on the cell vitality of human primary cells.

### DESCRIPTION OF PREFERRED EMBODIMENTS

### Preparation of Testing Reagents:

As testing reagents, different Chlorhexidine and Polyhexamethylene biguanide hydrochloride (PHMB) solutions were prepared with varying concentrations and buffers. Chlorhexidine-digluconate solution (CHX, 20% w/v in water, CAS 18472-51-0) was purchased from Sigma-Aldrich, Switzerland (article number C9394). Glycine was purchased as solid substance from Honeywell Fluka, Switzerland (CAS: 56-40-6). Polyhexamethylene biguanide hydrochloride was purchased as solid substance from Biosynth, UK (article number FP76704, lot number: B20V06202). As stock solution, a 10% (by weight per volume) PHMB solution in water was prepared. All of the PHMB testing reagents were prepared based on the 10% stock solution.

Buffers, according to Table 1 below, were prepared using a 0.05M NaOH solution and adding solid Glycine in an amount to lead to the Glycine concentration as indicated, pH given as measured with a pH electrode (914 pH/Conductometer Metrohm, 3 point calibration).

TABLE 1
Solutions and Buffers as used (all concentrations
are given for the final composition)

| Solution/Buffer | pH |
|---|---|
| 0.05M NaOH | 12.51 |
| 0.05M NaOH/0.05M Glycine | 11.06 |
| 0.05M NaOH/0.1M Glycine | 9.78 |
| 0.05M NaOH/0.2M Glycine | 9.27 |
| 0.05M NaOH/0.4M Glycine | 8.94 |

Polyhexanide (polyhexamethylene biguanide hydrochloride, PHMB, CAS Number 28757-47-3, also 32289-58-0) testing reagents were prepared from 10% PHMB stock solution in ultrapure water (weight per volume, ASTM Type 1 as provided by a Sartorius Arium Pro Water System, e.g. ultrapure according to ASTM D1193-06(2018)) and using the solutions and buffers as given in Table 1 and tested in different experiments according to Table 2 below.

TABLE 2
PHMB solutions as used in experiments (all concentrations
are given for the final composition)

| | Concentration (% | | |
|---|---|---|---|
| Experiment | by weight per | | |
| no. | volume) PHMB | Buffer | Observation |
| 1 | 0.05% | Water | Early |
| | | 0.05M NaOH/0.05M | biofilm |
| | | Glycine | formation |
| | | 0.05M NaOH/0.1M | |
| | | Glycine | |
| | | 0.05M NaOH/0.2M | |
| | | Glycine | |
| | | 0.05M NaOH/0.4M | |
| | | Glycine | |
| 2 | 0.015% | Water | |
| | | 0.05M NaOH | |
| | | 0.05M NaOH/0.1M | |
| | | Glycine | |
| 3 | 0.01% | Water | |
| | | 0.05M NaOH/0.05M | |
| | | Glycine | |
| | | 0.05M NaOH/0.2M | |
| | | Glycine | |
| | | 0.05M NaOH/0.4M | |
| | | Glycine | |
| 4 | 0.0002% | Water | |
| | | 0.05M NaOH | |
| | | 0.05M NaOH/0.05M | |
| | | Glycine | |
| | | 0.05M NaOH/0.2M | |
| | | Glycine | |
| 5 | 0.05 & 0.1% | Water | Dense |
| | | 0.05M NaOH/0.1M | biofilm |
| | | Glycine | |

CHX testing reagents were prepared from a liquid 20% CHX stock solution in ultrapure water and using the solutions and buffers as given in Table 1 and tested in different experiments according to Table 3 below.

TABLE 3
CHX solutions as used in experiments (all concentrations
are given for the final composition)

| Concentration CHX | Buffer | |
|---|---|---|
| 0.06% | Water | Early |
| | 0.05M NaOH / 0.4M | biofilm |
| | Glycine | formation |
| 0.12% | water | |

Moreover, a 0.9% NaCl solution (weight per volume) in ultrapure water was used as state of the art rinsing solution.

Apart from the above-mentioned solutions used in the in vitro experiments reported further below, the following final formulation in Table 3a for in vivo use was prepared and found to be stable and efficacious:

TABLE 3a
PHMB solution as used for in vivo testing (pH = 9.8 as measured)

| Substance | Concentration (w/v) |
|---|---|
| Water | ≥70% |
| NaOH | 0.2% |
| Glycerol | 5-10% |
| Poloxamer | 1-3% |
| Glycin | 0.75% (0.1M) |
| Preservative | 0.1% |
| PHMB (Polyhexanid) | 0.01-0.1% |
| Xylitol | 10% |
| Colorant | |
| PEG | 1-2% |
| Aroma oil | 0.3% |
| Calcium donor | 0.03% |

Another formulation for in vivo use was prepared and found to be stable and efficacious and is given in Table 3b below.

TABLE 3b
PHMB solution as used for in vivo testing (pH = 9.8 as measured)

| Substance | Concentration (w/v) |
|---|---|
| Water | ≥70% |
| NaOH | 0.2% |
| Poloxamer | 1-3% |
| Glycin | 0.75% (0.1M) |
| PHMB (Polyhexanid) | 0.01-0.1% |
| Xylitol | 4% |
| PEG | 1-2.5% |
| Aroma oil | 0.2% |

### Determination of the Antimicrobial Effect of Various Testing Reagents in an In Vitro Biofilm Model:

In order to test the antimicrobial effect of various testing reagents, the oral strain Streptococcus sanguinis, purchased from ATCC, was used. All experiments started with the preparation of an overnight culture of S. sanguinis in Brain-Heart-Infusion (BHI) medium, at 37° C. under aerobic conditions. After 16 hours, the bacterial suspension was centrifuged at 3000 rpm for 5 minutes. The supernatant was removed and the pellet was resuspended in 1 ml of Phosphate-Buffered-Saline (PBS, Sigma-Aldrich, Switzerland). The bacterial suspension was adjusted with PBS to reach an optical density of 0.5, which is equivalent to 10⁸ CFU/ml. For the antimicrobial experiments, a start inoculum of 10³ CFU/ml in BHI medium was used.

To model the early biofilm formation after setting of a dental implant, round shaped titanium discs (diameter of 16 mm, provided by Thommen Medical AG) were cleaned, heat-autoclaved and placed into a 24 well plate.

In a next step, these titan discs were pre-conditioned with the testing reagents or BHI medium/0.9% NaCl (control group).

The conditioned titanium discs were afterwards incubated with 1 ml/well of bacterial suspension (10³ CFU/ml) in BHI medium.

After 24 hours, the BHI medium was removed and the titanium discs were washed with the testing reagents for 10 minutes at 37° C. and 70 rpm.

To quantify the biofilm mass on the titanium discs, a crystal violet staining was performed. To this end, the testing reagents were removed with a pipette and 300 μ/well of crystal violet solution (0.1% in ultrapure water, purchased from Sigma-Aldrich Switzerland) were added and incubated for 10 minutes at room temperature.

After the incubation time, titanium discs were washed four times with distilled water (600 μl/well) and transferred to a new 24 well plate. In order to liberate the crystal violet stain from titan discs, 1 ml/well of acetic acid (33%) was added and incubated for 5 minutes at room temperature and 70 rpm. Duplicates of 100 μl respectively were transferred from every well to a new 96 well plate and the absorbance at 590 nm was measured, using a BioTek Epoch2 microplate reader.

In order to evaluate the antimicrobial effect of the testing reagents not only on the early biofilm formation but also on an older and denser biofilm, a similar experiment as described in the upper section was repeated using a start inoculum of 10⁶ CFU/ml and an incubation time of 72 hours.

To study the effect of alkaline pH on bacterial growth, a bacterial suspension of S. sanguinis with an optical density (600 nm) of 0.2 has been prepared either in PBS medium with a pH of 7.2 or in T. buffer (0.05M NaOH/0.1 M glycine, 0.03% CaCl2) with a pH of 9.7±addition of 0.015% PHMB. Next, 100 μl of the bacterial suspension was transferred to a 96 well plate and placed into a preheated (37° C.) Biotek reader. The optical density at 600 nm has been measured in 2 h intervals over 24 hours in order to assess bacterial behaviour in variable buffers.

### Cell Culture and Cytocompatibility Tests of Testing Reagents and Alkaline Buffers:

Mouse fibroblasts (L929 cell line) were used in this study as recommended cell line for cytotoxicity testing in accordance with EN ISO 10993-5.

The fibroblasts were purchased from ATCC and cultured in Dulbecco's Modified Eagle Medium-high glucose, supplemented with 10% fetal bovine serum and 1% penicillin-streptomycin (Sigma-Aldrich, Switzerland) in T75 flasks at 37° C. and 5% CO2. For the performance of the cytotoxicity experiments, L929 cells were seeded onto 96-well cell culture plates, 100 μ/well, at a density of 1×10⁶ cells/mL to reach about 80% confluence after 24 hours. At the next day, 100 μl of fresh medium spiked with varying concentrations (0.001, 0.005, 0.01, 0.05 and 0.1%) of CHX or PHMB were added.

As a control, cells were incubated with fresh medium without antiseptic agent.

Six replicate wells per concentration were tested.

After 60 minutes of incubation at 37°, the medium was removed and the wells were washed once with 100 μl of the fresh medium.

Thereafter, cells were incubated with 100 μL of the fresh medium containing 0.015 mg/ml AlamarBlue dye, for 2 hours at 37° C.

Finally, 100 μL of the media were removed from each well and transferred to a new 96-well plate and the absorbance was measured using a BioTek microplate reader (test wavelength: 570 nm; reference wavelength: 630 nm).

In order to test the cytocompatibility of alkaline buffers, a similar experiment was performed. However, the alkaline buffers were incubated for 10 minutes instead of 60 minutes.

The following alkaline buffers were tested:
a) 0.025 M NaOH, 0.025 M NaOH/0.05 M glycine, 0.025 M NaOH/0.05 M glycine/0.03% CaCl₂) (weight per volume in the final composition);
b) 0.05 M NaOH, 0.05 M NaOH/0.05 M glycine, 0.05 M NaOH/0.05 M glycine/0.03% CaCl₂) (weight per volume in the final composition);
c) 0.1 M NaOH, 0.05 M NaOH/0.1 M glycine, 0.05 M NaOH/0.1 M glycine/0.03% CaCl₂) (weight per volume in the final composition);
d) 0.05 M NaOH/0.1 M glycine;
e) 0.05 M NaOH/0.1 M glycine/0.03% CaCl₂) (weight per volume in the final composition).

### Human Primary Cells and the Effect of Antiseptic Substances and Ethanol on Cell Vitality:

Human periodontal ligament fibroblasts (HPDLF) were used in this study as test system, imitating closer the in vivo situation. The fibroblasts were purchased from ATCC and cultured in ScienCell FM medium, supplemented with 2% fetal bovine serum, 1% fibroblast growth factor and 1% penicillin-streptomycin (Sigma-Aldrich, Switzerland) in T75 flasks at 37° C. and 5% CO2.

To study the effect of antiseptic substances, at concentrations that are currently used in marketed products, the vitality of HPDLF cells was assessed. For this purpose, cells were seeded onto 24-well cell culture plates, 1 ml/well, at a density of 3×104cells/mL to reach about 80% confluence after 48 hours. At a next step, 300 μl T. buffer (0.05M NaOH/0.1 M glycine, 0.03% CaCl₂)) spiked with varying concentrations (0.06 and 0.12%) of CHX or (0.015, 0.025, 0.05 and 0.15%) PHMB were added. As a control, cells were incubated with T. buffer without antiseptic agent. Three replicate wells per concentration were tested. After 1 minute of incubation at 37°, the supernatant was removed and the wells were washed once with 600 μl of the fresh medium. Thereafter, cells were incubated with 600 UL of the fresh medium containing 0.015 mg/ml AlamarBlue dye, for 4 hours at 37° C. Finally, 100 μL of the medium were removed from each well and transferred to a new 96-well plate and the absorbance was measured using a BioTek microplate reader (test wavelength: 570 nm; reference wavelength: 630 nm).

In order to evaluate the effect of ethanol on cell vitality, HPDLF cells were seeded onto 96-well cell culture plates, 100 μ/well, at a density of 6×103 cells/mL to reach about 80% confluence after 24 hours. At the next day, 100 μl of fresh medium spiked with varying concentrations (10, 20 and 50%) of ethanol were added. Additionally, the developed T. buffer was spiked with 10, 20 and 50% ethanol. As a control, cells were incubated with fresh medium without ethanol. Three replicate wells per concentration were tested. After 5 minutes of incubation at 37°, the medium was removed and the wells were washed once with 100 μl of the fresh medium. Thereafter, cells were incubated with 100 μL of the fresh medium containing 0.015 mg/ml AlamarBlue dye, for 2 hours at 37° C. Finally, 100 μL of the medium were removed from each well and transferred to a new 96-well plate and the absorbance was measured using a BioTek microplate reader (test wavelength: 570 nm; reference wavelength: 630 nm).

### Results and Discussion

### Compatibility of Testing Reagents in Alkaline Buffers:

Polyhexamethylene biguanide hydrochloride (Polyhexanide, PHMB) is a chemical biocide. There are six different PHMB product types identified, possessing combinations of amine, guanidine and cyanoguanidine end-groups.

The antibacterial activity of PHMB depends on the molecular structure.

Minimum requirements are met by more than 2 biguanide moieties and 5-7 methylene groups as a spacer.

The biguanide moieties of PHMB are strong bases and monoprotonated at a pH value of 7 (pKa1≤2-3; pKa2≤10.5-11.5) resulting in a polycation with a positive charge at each biguanide moiety.

The positively charged moieties are believed bind to the negatively charged phosphate head groups of phospholipids at bacteria cell walls, leading to increased fluidity, permeability and loss of integrity, followed by the death of the organism.

PHMB can be seen as virtually detoxified CHX, as the molecular structure of PHMB monomers closely resembles the structure of CHX molecules, except for the terminal NH-group of CHX consisting of 4-chloroaniline (4-CA). Similar to PHMB, the biguanide moiety of CHX with a pKa≤10.8 makes it to a strong base.

In general, inorganic bases as sodium hydroxide lead to a precipitation of PHMB and CHX in case of pH≥pka value, for example for 0.05 M NaOH with a pH of 12.7.

Sodium hydroxide on the other hand is known to induce an alkaline saponification reaction with the phospholipid membrane of bacteria, causing a disruption of the membrane and finally cell death.

Surprisingly, there is a synergistic effect of PHMB and sodium hydroxide, leading to an increased bacterial death or allowing for a reduced active concentration for achieving the same effect.

To implement this in practice, however also further a buffer has to be formulated that prevents the precipitation of PHMB but still allows sufficient hydroxyl ion availability to achieve an alkaline saponification.

Therefore, different buffer compositions were tested for the precipitation of PHMB and CHX, as given in Table 1.

The results of these precipitation tests were as follows (precipitation determined by visual inspection/visible clouding, pH as measured):
0.05 M NaOH/0.05 M glycine/CHX 0.06%, pH 11.06: Precipitation
0.05 M NaOH/0.1 M glycine/CHX 0.06%, pH 9.9: No precipitation
0.05 M NaOH PHMB 0.05%, pH 12.51: Precipitation
0.05 M NaOH/0.05 M glycine/PHMB 0.05%, pH 11.06: No precipitation
0.05 M NaOH/0.1 M glycine/PHMB 0.05%, pH 9.9: No precipitation.

The concentrations of 0.06% and 0.12% w/v CHX were based on common mouth rinsing solutions (e.g. Chlorhexamed products), and 0.05% PHMB was based on wound rinsing solutions with concentrations in the range of 0.04% w/v.

Based on the pKa value of 10.8 for the strongest base within the CHX molecule, precipitation occurs using a 0.05 M NaOH/0.05 M glycine buffer with a pH of 11.2 (pH≥pKa).

By increasing the glycine concentration to 0.1 M and thus decreasing the pH, no precipitation of CHX occurs.

In contrast to CHX, the pKa value of the strongest base within the PHMB molecule is in the range of 10.5-11.5. Thus, no precipitation of PHMB was observed using a 0.05M NaOH/0.05 M glycine buffer (pH 11.06). However, a 0.05 M NaOH solution (pH 12.5) without the addition of glycine induces also precipitation of PHMB.

Therefore, it can be concluded that for PHMB a minimum of 0.05 M glycine is appropriate. As the pH of 11.06 for a 0.05 M NaOH/0.05 M glycine is close to the pKa value of the strongest base of PHMB, for some applications it is advisable to use a 0.05 M NaOH solution spiked with 0.1 M glycine, so a solution having a pH in the range around or below 10.

### Synergistic Antimicrobial Effect of Testing Reagents in Alkaline Buffers:

In a study of Ojan Assadian et al.2011 (Assadian O, Wehse K, Hübner N O, Koburger T, Bagel S, Jethon F, Kramer A. Minimum inhibitory (MIC) and minimum microbicidal concentration (MMC) of polihexanide and triclosan against antibiotic sensitive and resistant Staphylococcus aureus and Escherichia coli strains. GMS Krankenhhyg Interdiszip. 2011; 6(1)), a minimal inhibitory concentration (MIC) in the range of 1-2 μg/ml (0.002% w/v) was reported for Streptococcus aureus and Escherichia coli treated with PHMB solutions. To detect a possible synergistic effect of PHMB and an alkaline buffer, an early biofilm of Streptococcus sanguinis was cultured on titan discs for 24 hours, before the discs were rinsed with different PHMB solutions, containing 0.002% PHMB similar to the reported MIC. As a control, the biofilm was cultured in BHI medium.

The PHMB solution (0.002% in nanopure water) did not lead to a reduced bacterial amount, suggesting that 0.0002% is below the MIC for Streptococcus sanguinis in this assay. However, if PHMB (0.002% was prepared with 0.05 M NaOH/0.05 M glycine buffer with a pH of 11.06, a significant reduction in absorbance and thus in bacterial amount was observed.

Similar results are obtained for PHMB (0.002%) prepared with a 0.05 M NaOH/0.2 M glycine buffer with pH of 9.27.

In contrast, PHMB (0.002% in distilled water) spiked to a 0.05 M NaOH solution with a pH of 12.5 (no precipitation visible likely due to low PHMB concentration used) did not achieve a reduced bacterial amount, as the pH≥pKa did not allow a positively charged PHMB molecule.

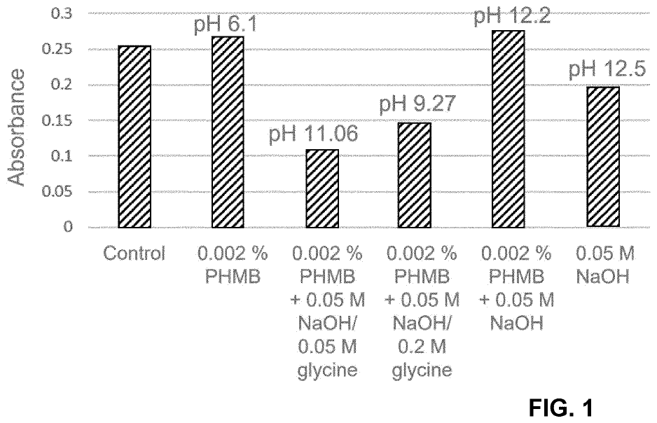

FIG. 1 graphically illustrates the results of the absorbance for the situation of low PHMB concentrations, a higher absorbance indicating a lower effect on the biofilm.

In a next experiment, a higher concentration of PHMB (0.01% in ultrapure water) was tested on early biofilm formation of Streptococcus sanguinis, cultured on titan discs. Also in this experiment, a synergistic effect of 0.01% PHMB and NaOH/glycine buffer was observed.

The best results, in terms of reduced bacterial amount, were achieved using a 0.05 M NaOH/0.05 M glycine (pH 11.06) buffer and a 0.05 M NaOH/0.2 M glycine (pH 9.27) buffer. Higher concentrations of glycine e.g. 0.4 M (pH 8.9) did not lead to a significant reduction of bacterial amount, compared to lower concentrations of glycine e.g. 0.05 M-0.2 M.

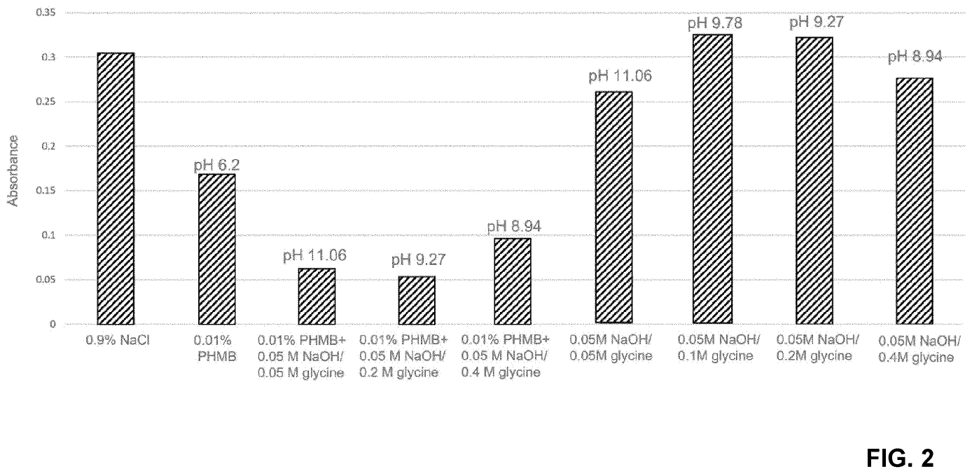

FIG. 2 graphically illustrates the results of the absorbance for the situation of low PHMB concentrations, a higher absorbance indicating a lower effect on the biofilm.

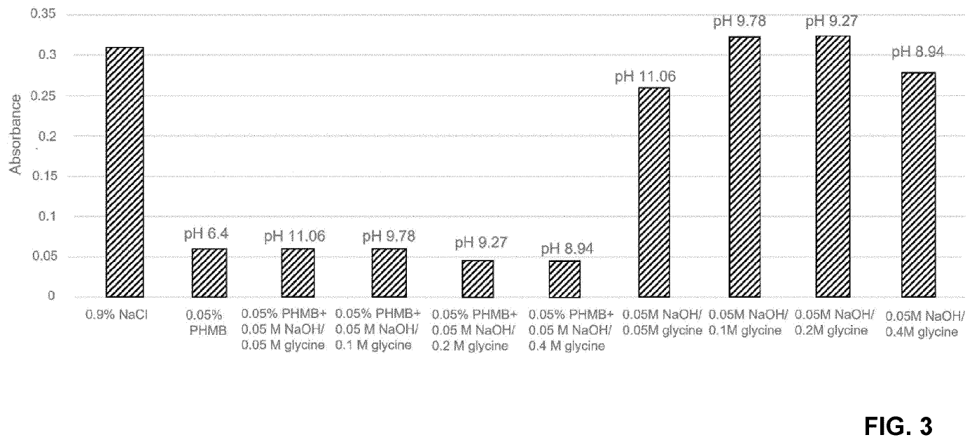

As one can see from the results as illustrated in FIG. 3, in the early biofilm model, no pronounced synergistic effect can be observed, if 0.05% PHMB was added to alkaline buffers.

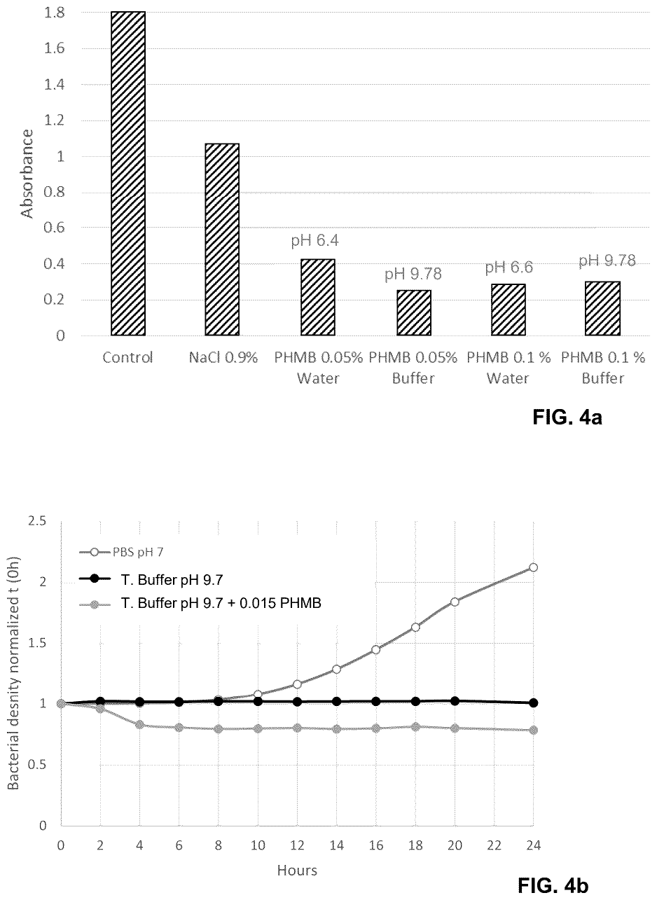

To verify, if the early in vitro biofilm model set up with low concentrated bacterial start inoculum and short incubation time, can prohibit a possible synergistic effect of higher PHMB concentration e.g. 0.05% in alkaline buffers, the experiment was repeated using a denser and older biofilm model (start inoculum 10⁶ CFU/ml, incubation time 72 hours). By using the adapted experiment design, a synergistic effect of 0.05% PHMB in 0.05 M NaOH/0.1 M glycine buffer was obtained, see the results in FIG. 4a.

To assess the effect of pH and antiseptic substance on bacteria behaviour, a bacterial suspension of S.sanguinis was measured over 24 hours at an optical density of 600 nm and at 37° C. The incubation in neutral PBS, showed a significant growth of S.sanguinis over the time, whereas S.sanguinis grown in T. buffer with a pH of 9.7 showed a significant inhibitory effect. The addition of 0.015% PHMB to the alkaline T. buffer with a pH of 9.7 resulted in a killing of bacteria over time, see the results in FIG. 4b.

### Biocompatibility of Testing Reagents:

In order to test the biocompatibility of the different alkaline buffers, L929 murine fibroblasts were used.

Cells were seeded in a 96 well plate at a density of 1×10⁶ cells/ml and cultured for 24 hours, before they were treated with the different alkaline buffers for 30 minutes.

As a control, cells were cultured in fresh medium.

After the incubation time, the metabolic activity, used as an indirect marker for cytotoxicity, was measured with an AlamarBlue assay. Vital cells were able to transform the dye by redox reaction to a fluorescent product. Hence, the highest metabolic activity was observed for the control. A decreased metabolic activity goes along with possible toxic effects.

The incubation with pure sodium hydroxide (0.025 M, 0.05 M and 0.1 M) lead to a significant reduction in metabolic activity.

Also, alkaline buffers containing 0.05 M NaOH/0.05 M glycine (pH 11.06) and 0.1 M NaOH/0.05 M glycine showed clear toxic effects.

In comparison with the buffers mentioned before, alkaline bufffers containing 0.025 M NaOH/0.05 M glycine or 0.05 M NaOH/0.1 M glycine resulted in metabolic activities comparable to the control.

Moreover, it was observed, that the addition of 0.03% CaCl₂) to the alkaline buffers can have additional beneficial effects on the metabolic activity.

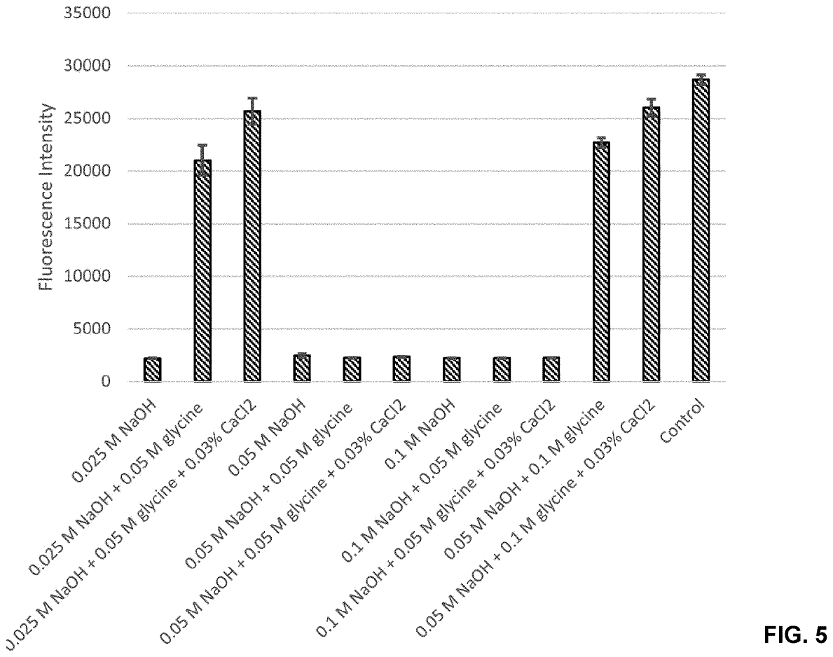

FIG. 5 graphically illustrates the results of the biocompatibility tests of the different alkaline buffers. The pH values of the samples in this figure are given in Table 4.

TABLE 4
measured pH values of the samples illustrated in FIG. 5

| Sample | pH |
|---|---|
| 0.025M NaOH | 12.15 |
| 0.025M NaOH / 0.05M glycine | 10.42 |
| 0.025M NaOH / 0.05M glycine / 0.03% CaCl₂ | 10.42 |
| 0.05M NaOH | 12.51 |
| 0.05M NaOH/ 0.05M glycine | 11.06 |
| 0.05M NaOH/ 0.05M glycine / 0.03% CaCl₂ | 11.06 |
| 0.1M NaOH | 12.71 |
| 0.1M NaOH / 0.05M glycine | 11.24 |
| 0.1M NaOH / 0.05M glycine / 0.03% CaCl₂ | 11.24 |
| 0.05M NaOH / 0.1M glycine | 9.78 |
| 0.05M NaOH / 0.1M glycine / 0.03% CaCl₂ | 9.78 |

In order to evaluate the biocompatibility of PHMB compared with the one of CHX, L929 murine fibloblasts were treated for 60 minutes with different concentrations of PHMB and CHX, respectively, supplemented within the medium.

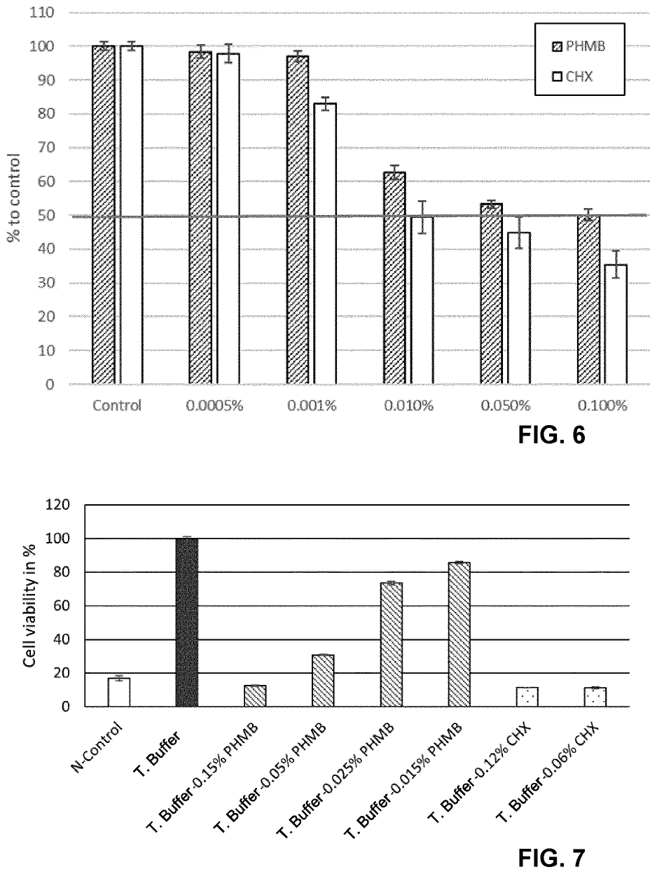

After the incubation with the antiseptic agents, the metabolic activity was measured using an AlamarBlue assay. The data were normalized to the control (cells in fresh medium) and thus set to 100% metabolic activity. To compare the two antiseptic agents, the IC₅₀ value, representing the concentration that allow 50% cell survival (bold horizontal line), was calculated for each one. The calculation revealed a IC₅₀ value≤0.1% for PHMB and ≤0.01% for CHX., see FIG. 6.

In order to evaluate the cell viability of the antiseptic agents PHMB and CHX, human primary cells (HPDLF) were treated for 1 minutes with different concentrations of PHMB and CHX, supplemented within T. buffer. After the incubation with the antiseptic agents, the metabolic activity was measured using an AlamarBlue assay (after 4 h). Low cell viability was observed for cells treated with CHX at the tested concentration of 0.06 and 0.12% in T. buffer. For PHMB, low cell viability was obtained for cells treated with PHMB at a concentration of 0.15%, whereas PHMB at 0.05% only led to a reduced cell viability. PHMB at 0.025% and 0.015% revealed cell viabilities in the range of the T. buffer control. Cells treated with the negative control (5% DMSO) showed a low cell viability. See FIG. 7.

It is to be noted that this is valid for antiseptic applications. If the application is rather anti-inflammatory (e.g. in the form to be used against mucositis), also higher concentrations of PHMB up to 0.2% can be used. The additional advantage relative to the use of CHX is then that contrary to using CHX based formulations, there is no staining effect on the teeth with the application of the PHMB formulation, and PHMB shows higher biocompatibility than CHX.

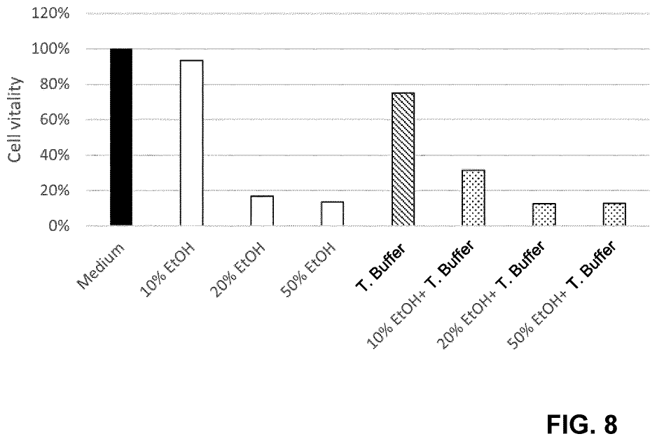

Finally, the influence of ethanol on cell vitality was investigated. HPDLF cells were grown in FM cell culture medium as control. The effect of the addition of ethanol was studied by either spiking the cell culture medium with 10, 20 and 50% ethanol or the developed T. buffer and corresponding amounts of ethanol. After 5 minutes incubation with the different test substances, cell vitality was measured by the AlamarrBlue assay, performed as described before. Ethanol at a concentration of 20 and 50% spiked to cell culture medium showed a significant decrease in cell vitality. Ethanol spiked to the T. buffer also caused a negative effect on cell vitality, see FIG. 8.

### Key Findings:

Some of the key findings of the experimental evidence can be summarised as follows:
A particularly pronounced synergistic effect of PHMB and alkaline buffers was obtained for PHMB concentrations in the range of 0.002%-0.04%, in an early biofilm formation model (start inoculum 10³ CFU/ml, incubation time 24 hours) with Streptococcus sanguinis. In experiments using an early biofilm formation set up, little synergistic effect of PHMB and alkaline buffers was observed with PHMB concentrations≥0.05%.
Alkaline buffers containing 0.05 M NaOH and ≤0.05 M glycine tend to lead to too high pH and to pH≥pKa, resulting in a reduced antimicrobial activity. Buffers containing 0.05 M NaOH and glycine≥0.4 M resulted also in less antimicrobial activity. Best performance in terms of synergistic effect (antimicrobial activity) was achieved with buffers containing 0.05 M NaOH and 0.05 M-0.2 M glycine (pH range 11.06 to 9.8).
A synergistic effect with PHMB (0.05%) and an alkaline buffer (0.05 M NaOH/0.1 M glycine) was proven in an in vitro biofilm model with higher bacterial load (10⁶ CFU/ml) and longer incubation time (72 hours).
Biocompatibility tests with L929 murine fibroblasts showed a good tolerance of alkaline buffers containing 0.025 M NaOH/0.05 M glycine or 0.05 M NaOH/0.1 M glycine+0.03% CaCl₂) (pH 9.78). This indicates that alkaline buffers composed of NaOH/glycine with a pH≤10 can be viewed as biocompatible.
Biocompatibility tests with L929 murine fibroblasts and PHMB and CHX revealed the following IC50 values: PHMB≤0.1%, CHX≤0.01%. These data indicate a higher biocompatibility for PHMB than for CHX.
Cell vitality after exposure to the proposed formulations is very good compared with other products; the presence of ethanol negatively affects the cell vitality, so alcoholic components are rather to be avoided
the proposed provides an optimum balance between high antimicrobial activity and biocompatibility for oral tissue cells.

1. An aqueous antimicrobial composition comprising or consisting of the following components:
(a) polyhexanide or a salt thereof in a concentration in the range of 0.001-0.2% w/v;
(b) an organic or inorganic buffer different from a) with at least one pKs value in the range of 8.5-11.5 in a concentration in the range of 0.01-1 M;
(c) further additives in a concentration in the range of 0-20% w/v;
(d) water;
wherein the pH value of the composition is in the range of 8-11.5.

2. The composition according to claim 1, wherein the polyhexanide of component (a) has a weight average molecular weight Mw in the range of 1500-4000 g/mol, or in the range of 2400-3000 g/mol;
wherein the polyhexanide of component (a) has a polydispersity (PDI) in the range of 1.4-2.2, preferably or in the range of 1.7-2.8;
and/or wherein the polyhexanide (PHMB) of component (a) takes the form of polyhexamethylene biguanide hydrochloride.

3. The composition according to claim 1, wherein the concentration of the polyhexanide (PHMB) of component (a) in the composition is in the range of 0.002-0.15% w/v or 0.002-0.1% w/v, or in the range of 0.005-0.07% w/v or 0.005-0.05% w/v, or in the range of 0.007-0.03% w/v or 0.007-0.02% w/v or 0.007-0.015% w/v.

4. The composition according to claim 1, wherein the organic or inorganic buffer of component (b) is selected from the group consisting of:
amino acid;
bicarbonate buffer, selected from the group consisting of: carbonate bicarbonate buffer, triethyl ammonium bicarbonate buffer;
borate buffer, including sodium borate buffer;
(acetic acid) ethanolamine buffer;
or a combination or mixture thereof.

5. The composition according to claim 1, wherein the organic or inorganic buffer of component (b) has at least one pKs value in the range of 9-10.5, or in the range of 9.5-10.

6. The composition according to claim 1, wherein the concentration of the organic or inorganic buffer of component (b) in the composition is in the range of 0.05-0.8 M, or in the range of 0.08-0.5 M, or in the range of 0.1-0.2 M.

7. The composition according to claim 1, wherein the additives of component (c) are selected from the group consisting of: surfactants, including ionic and non-ionic surfactants, thickeners, compatibilizers or mixtures or combinations thereof.

8. The composition according to claim 1, wherein the concentration of the additives of component (c) is in the range of less than 10% w/v or less than 5% w/v, wherein dyes as part of component (c) are present in a concentration in the range less than 0.2% w/v, preferably or less than 0.1% w/v, or in the range of 0.001-0.05% w/v or 0.0 w/v.

9. The composition according to claim 1, wherein the composition has a pH value in the range of 8-11, or in the range of 8.5-10.5, or in the range of 9.5-10.

10. The composition according to claim 1, wherein the polyhexanide of component (a) has a weight average molecular weight Mw in the range of 2400-3000 g/mol, wherein the polyhexanide of component (a) takes the form of polyhexamethylene biguanide hydrochloride, and wherein the concentration of the polyhexanide (PHMB) of component (a) in the composition is in the range of 0.007-0.015% w/v,
wherein the organic or inorganic buffer of component (b) is selected as glycine in a concentration of the organic or inorganic buffer of component (b) in the composition in the range of 0.1-0.2 M,
and wherein the concentration of the further additives of component (c) is less than 0.01% w/v, or in the range of 0.001-0.01% w/v.

11. The composition according to claim 1 for the treatment or prevention of bacterial infection or bacterial colonisation or both, including of the skin, wounds, including of the mouth.

12. The composition according to claim 11 for the treatment and/or prevention of patients during and/or after implantation, including during and/or after dental implantation, including in the form of a rinsing or washing composition or drip solution, including after-care treatment over the weeks following implantation.

13. The composition according to claim 1, wherein, next to components (a)-(d) the composition further comprises the following component:
(e) at least one sugar alcohol having at least three carbon atoms, in a concentration of up to 75% w/v, or in a concentration of up to 70% w/v or in the range of 5-50% w/v or in the range of 10-40% w/v or 20-30%,
wherein said sugar alcohol of component (e) can be selected from the group consisting of glycerol, erythritol, threitol, arabitol, ribitol, mannitol, sorbitol, xylitol, galactitol, fucitol, iditol, inositol, volemitol, isomalt, maltitol, lactitol, maltotriitol, maltotetraitol, or a combination thereof.

14. The composition according to claim 1, wherein it is free from ethanol or comprises less than 10% w/v or less than 5% w/v or less than 2% w/v of ethanol.

15. The composition according to claim 1, wherein it is free from linear or branched alkyl or arylalkyl monohydric alcohols with 1-9 or 1-6 carbon atoms,
or is free from methanol, ethanol, propanol, 1-phenyl-1-propanol or a combination thereof,
or comprises less than 10% w/v or less than 5% w/v or less than 2% w/v or less than 1% w/v of such linear or branched alkyl or arylalkyl monohydric alcohols.

16. A method of using a composition according to claim 1 for the disinfecting non-therapeutic treatment of surfaces, including non-living or biomaterial surfaces, by dip coating, spraying, dripping, or for storage and/or implantation preparation of devices, including implants or biomaterials for soft or hard tissue regeneration.

17. The method according to claim 16, wherein the composition is used for storing an implant or a biomaterial for soft or hard tissue regeneration, including a dental implant, in immersion before use, or is packaged together or as kit of part with an implant or a biomaterial for soft or hard tissue regeneration, including a dental implant, for the implant or material to be immersed or wetted by the composition shortly before implantation.

18. A method for cleaning and sanitizing and/or disinfecting a surface and providing residual inhibition against microbes, the method comprising: a) applying the composition of claim 1 to a surface, article and/or substrate.

19. The composition according to claim 1, wherein the organic or inorganic buffer of component (b) is selected is selected from the group consisting of: glycine, alanine, valine, leucine, isoleucine, or a combination or mixture thereof.

20. The composition according to claim 1, wherein the additives of component (c) are selected from the group consisting of:
anionic surfactants, including selected from alkyl sulfates, alkyl ether sulfates, alkyl sulphonates, alkylbenzyl sulfonates, α-olefin-sulphonates, alkylamide sulphonates, alkarylpolyether sulphates, alkylamidoether sulfates, alkyl monoglyceryl ether sulfates, alkyl monoglyceride sulfates, alkyl monoglyceride sulfonates, alkyl succinates, alkyl sulfosuccinates, alkyl ether sulfosuccinates, alkyl sulfosuccinamates, alkyl amidosulfosuccinates; alkyl sulfoacetates, alkyl phosphates, alkyl ether phosphates, alkyl ether carboxylates, alkyl amidoethercarboxylates, acyl lactylates, alkyl isethionates, acyl isethionates, carboxylate salts and amino acid derived surfactants such as N-alkyl amino acids, N-acyl amino acids, alkyl peptides, and mixtures thereof,
amphoteric surfactants, including selected from alkyl betaines; alkylamido betaines; alkylamido sultaines; alkyl mono- and di-amphocarboxylates; amine oxides; and mixtures thereof,
nonionic surfactants or thickeners or compatibilizers, including selected from ethoxylated fatty alcohols, ethoxylated alkylphenols, ethoxylated Guerbet alcohols, ethoxylated vegetal oils, polypropylene glycol, polyethylene glycol, block copolymers of propylene glycol and/or ethylene glycol, ethoxylated sorbitan esters, sorbitan esters, alkyl polyglucosides, alkyl glucamides, and mixtures thereof;
anti-corrosion agents, perfumes, dyes, stabilisers, complexing agents, organic solvents, including alcohols, disinfectants, preservatives,
or mixtures or combinations thereof.

21. The composition according to claim 11 for the treatment and/or prevention of patients during and/or after implantation, in the form of a rinsing or washing composition or drip solution, including after-care treatment over the weeks following implantation.
